(19) United States
(12) Patent Application Publication
(10) Pub. No.: US 2012/0048807 A1
(43) Pub. Date: Mar. 1, 2012

(54) Adsorbent Product for the Removal of Hydrocarbon Pollutants, and Method for Removing Hydrocarbon Pollution, In Particular at the Surface of the Water, Using Said Product

(75) Inventors: Sami Hosagasi, Paris (FR); Bulent Birden, Izmir (TR)

(73) Assignee: ECOPOMEX S.A.M., Monaco (MC)

(21) Appl. No.: 13/123,308

(22) PCT Filed: Oct. 13, 2009
(86) PCT No.: PCT/FR2009/001204

§ 371 Date: Apr. 8, 2011

(30) Foreign Application Priority Data
Oct. 13, 2008 (FR) 0805630

(51) Int. Cl. C02F 1/28; B01J 20/32; B01J 20/20; B01J 20/28

(52) U.S. Cl. 210/691; 502/418; 502/437

(57) ABSTRACT

The adsorption properties of the adsorbent product, based on a porous mineral such as particularly pumice stone, result from the carbon formed on the walls of the pores of the mineral by cracking of an organic product, such as sugar or treatment plant sludges, previously impregnated in the pores of the mineral, the carbon thus formed making the product hydrophobic. After absorption of pollutant hydrocarbons by the product, the impregnated mineral is heated in a heat treatment unit, in the absence of oxygen, to bring it to a sufficient temperature to evaporate the hydrocarbons and/or decompose by cracking the organic product or hydrocarbon molecules and form or regenerate the carbon deposit. Application to the manufacture and to the recycling of an adsorbent product for the depollution particularly of bodies of waters or rivers polluted by hydrocarbons.

### BACKGROUND

The present invention relates to a product intended to eliminate hydrocarbon pollutions which can particularly occur by the presence of hydrocarbons in water, and to a process for using such a product. The product of the invention is especially intended for the depollution of seas, rivers or lakes polluted by hydrocarbons but can also be used in treatment plants, car parks, garages and all places where hydrocarbon pollution occurs.

Depollution by adsorption methods are already well known. Generally, adsorption is a physical phenomenon which fixes molecules on the surface of a solid called adsorbent. This phenomenon is used to recover undesirable fluid, liquid or gaseous molecules dispersed in another fluid or solvent such as water or air.

The adsorbent which is principally used in practice is active carbon. Adsorption on active carbon is intended to treat organic matters not found in high quantities in the solvent. The active carbon is commonly used therefore for many filtering applications in which the fluid, water or air, passes through a filter charged with active carbon as described in FR 2107069.

Other absorbent products are known, for example by GB 1204353 or FR 2137531 which describes a porous alumina including carbon formed on the walls of the pores. However, this product, by its particle size and its density does not allow a hydrophoby and a sufficient buoyancy to be ensured for the targeted application.

Other absorbent products are also known, more suitable to a fluid absorption use, especially hydrocarbons, by spreading them over the surfaces covered by the said hydrocarbons. These products can be synthetic, based on materials of mineral origin, vegetal origin and polymers. However, most of these products rapidly release the absorbed hydrocarbons which makes them not very efficient and complicates their use. Moreover, almost all of these absorbent products can be used only once. After use, they are often burnt or dumped in technical burial centres which creates other forms of pollution. Lastly, some of these products do not float and among those which do, the buoyancy is very limited over time.

Document DE 3142275 describes a pollutant hydrocarbon recovery process by use of pumice stone as absorbent and treatment of this stone when it is impregnated with hydrocarbons by centrifugation and distillation heat treatment. However, the product used is not hydrophobic and its buoyancy is insufficient. Although it allows hydrocarbons to be recovered by adsorption, the treatment of the charged product at best allows a regeneration to original condition to be ensured and therefore with the disadvantage of an insufficient hydrophoby and buoyancy implying difficulties in recovering the product charged with hydrocarbons and a relatively low adsorption rate efficiency.

For applications of the type mentioned above, the absorbent and/or adsorbent product must combine the following various properties:
on the one hand, a sufficient hydrocarbon adsorption capacity and, on the other hand, minimum water absorption so that the adsorbent product charged with the maximum possible amount of hydrocarbons can be recovered,
maximum buoyancy to allow the product to remain in contact with the pollutants as long as possible, avoiding that the product falls to the bottom of the water, even when charged with pollutants, to facilitate its recovery,
possibility of treatment and recycling after adsorption especially including: the recovery of the product containing the adsorbed hydrocarbons, its treatment to prevent secondary pollution by the recovered hydrocarbons and, preferentially, the recycling of the adsorbent product and, possibly, of the absorbed pollutants.

One of the important features is therefore that the product be as hydrophobic as possible. However, the products or techniques used to make the basic product hydrophobic are often very expensive.

Certain known products are hydrophobic and have hydrocarbon adsorption capacities which are considered very high. They also have a fairly low density allowing them to float on the water and thus facilitate their recovery. Products of this type are particularly described in FR-A-2105752, FR-A-2065206, JP-A-56078628, JP-A-11076811.

Moreover, a pumice stone which has a carbon content greater than 5% and specific hydrocarbon adsorption properties whilst being hydrophobic is also known. The time this pumice stone stays on the surface of the body of water to be depolluted is between two minutes and eight hours, especially between three minutes and two hours. These relatively short times may be insufficient to adsorb a maximum of hydrocarbons. Also, this creates a constraint concerning the recovery of the pumice stone which must be done therefore relatively quickly after it has been spread and in a time also fairly short. Failing this, the insufficient buoyancy of such products means that a substantial part of the adsorbent product may be immersed before it can be recovered. What is more, these products are manufactured by the absorption of hydrocarbons then calcination to generate the carbon deposit required on the walls of pores of the pumice stone to make it adsorbent and hydrophobic. The manufacture of the product itself is therefore a source of pollution.

The recycling of the pumice stone after adsorption of the hydrocarbons and recovery on the surface of the water is done by calcination to evacuate the adsorbed hydrocarbons. This has the advantage of being able to possibly reform the carbon layer on the walls of the pumice stone and therefore to make it again directly usable. But this also poses the problem of correct control of the combustion as this is done at high temperature, and of the control of the atmosphere in the calcination oven to obtain a homogeneous product, and of the treatment of the fumes.

### SUMMARY OF THE INVENTION

The aim of the present invention is to solve the problems mentioned above and especially to allow the manufacture of an adsorbent product especially adapted for the depollution of bodies of water or similar by adsorption of the surface hydrocarbons. Its aim is to facilitate the manufacture of such a product by the use of a process less polluting than those used previously. Its aim is also to improve the efficiency and the yield of the product and its recycling.

With these targets in mind, the subject of the invention is an adsorbent product for the elimination of hydrocarbon pollutions especially present on the surface of water, this product being based on a porous mineral the adsorption properties of which result from the carbon formed on the walls of the pores of the said mineral. According to the invention, the product is characterised in that the porous mineral is pumice stone or perlite and the carbon formed on the walls of the pores is obtained by cracking of an organic product previously impregnated in the pores of the said mineral, the resulting product being hydrophobic.

The organic product preferentially mainly consists of sugar or treatment plant sludges. By sugar, we in particular mean common sugar or saccharose but also the various similar organic compounds including saccharose and other mono, bi or polysaccharides.

The porous mineral is particularly pumice stone or perlite or zeolite.

The aim of the invention is also a process for eliminating hydrocarbon pollutions, especially present on the surface of water, characterised by the use of an adsorbent product such as defined above and in that, after the adsorbent product has been spread on the pollutant hydrocarbons and has adsorbed the said hydrocarbons, the product impregnated with hydrocarbons is placed in a heat treatment unit brought, in the absence of oxygen, to a predetermined temperature such that the hydrocarbons are evaporated and the product is thus returned to its initial and reusable state which enables it to be recycled.

Preferentially, the treatment temperature is from 200 to 450° C.

The specific heat treatment according to the process of the invention consists in fact in ensuring the elimination by evaporation of the greater part of the hydrocarbons absorbed in the product and also in regenerating, as required, the carbon deposit on the surface of the walls of the pores of the porous mineral used.

Another specific feature of the process lies in the process for obtaining the product defined above according to which the carbon formed on the walls of the pores of the said porous mineral is formed by cracking of molecules of an organic product previously impregnated in the pores of the said mineral, this organic product being preferentially sugar or treatment plant sludges.

The porous mineral chosen is preferentially pumice stone of a calibre between 60 microns and 16 mm and a grain density lower than 700 kg/m3 and an unpacked dry density lower than 350 kg/m3. After selection of the stones with required characteristics, the foreign stones and the dust are separated from the pumice stone, by techniques of known types, such as washing and flotation for example, then the pumice stone is dried so that its humidity ratio will be lower than 40%.

### DETAILED DESCRIPTION OF THE PREFERRED EMBODIMENT(S)

According to a specific embodiment, the porous mineral thus prepared is immersed in a liquid mix including water and sugar to impregnate the said mineral with the said mix then the impregnated mineral is heated in a heat treatment unit, in the absence of oxygen, to bring it to a sufficient temperature to decompose by cracking the sugar molecules and therefore form a carbon deposit on the walls of the pores of the porous mineral.

Preferentially,
the liquid mix includes 10 to 20% of sugar in weight, preferentially 15 to 20%,
the liquid mix also includes lemon juice, in a proportion of around 1% in weight, which allows the sugar to be diluted uniformly in the water,
the liquid mix can also include a low proportion of gas-oil of around 0.5 to 1%,
the impregnation time is typically around several minutes, between 3 and 10 minutes, for example around 5 minutes,
the heating temperature is typically between 500 and 600° C., sufficient to ensure the evaporation of the other components of the mix and the cracking of the carbonated molecules,
a nitrogen atmosphere is maintained in the oven replacing the oxygen.

The adsorbent product obtained typically has a carbon ratio of 2 to 4% in weight. The product thus ready for use allows, according to the viscosity of the hydrocarbons, and according to the time the product remains in contact with the polluted water, the adsorption of hydrocarbons at a ratio typically higher than 15% of its volume, and can reach 25% or even more.

Preferentially, as stated above, a liquid mix will be used especially including sugar. However, treatment plant sludges can also be used. Indeed, the use of treatment plant sludges has the advantage that they include organic matters in the molecules in which the number of carbon atoms is high thus forming long molecular chains which enable, during cracking, a lower loss of carbon. Comparatively, organic matters in which the number of carbon atoms is relatively low, such as C8H18 for example, immediately vaporise during cracking. When the number of carbon atoms increases, for example C11-H22-O11, the evaporation is lower and therefore the quantity of carbon which can remain on the walls of the pores of the porous material increases. Thus, the carbon ratio remaining in the pumice stone after cracking done on the pumice stone impregnated with petrol is only 2%. With a sugar solution, according to the invention, this ratio increases to around 25%. By using treatment plant sludges, general formula of C20-H40-OₓN_{y}P_{z} type, this ratio can reach around 80%. This high ratio would be especially advantageous. However, these sludges can fairly often contain products such as heavy metals which are dangerous for human health and the environment. Consequently, during the cracking, the gases given off must then be captured and treated which reduces the economic interest of the process. Also, certain sludge components, such as these heavy metals, could resist the heat treatment and thus remain in the pumice stone. Thus, in spite of the interest of these sludges, sugar will generally be preferred as organic product used according to the invention.

In the global process according to the invention, apart from the interest of the process to obtain the original product, another especially advantageous aspect concerns the recycling of the product after the said product has absorbed the pollutant hydrocarbons. During the heat treatment operation, similar to the cracking of sugar done for the preparation of the new product, the hydrocarbons absorbed in the product evaporate and regenerate, if required, by cracking of the said hydrocarbons, the carbon deposited on the walls of the pores. The pollution products stored in the adsorbent product are thus eliminated from it and it is returned more or less to its initial condition again ready for a new use. Moreover, the evaporated hydrocarbons can be captured and treated by a condensation system and recovered for a possible use.

Other features and advantages of the invention will become apparent on reading the following description of a typical example of all the manufacturing, use and recycling operations for the product according to the invention.

First of all, 1 m³ of pumice stones was taken with a calibre greater than 2 mm and an unpacked dry density lower than 300 kg/m³. Among these pumice stones, those which had grain densities lower than 600 kg/m³ were chosen.

The pumice stones were then cleaned by washing and flotation, then the pumice stones were dried so that their humidity was around 20%.

To prepare the effective liquid mix for around 1 m³ of pumice stones, a concentrate was first prepared by mixing 47.5 kg of water, 50 kg of sugar in powder form and 2.5 kg of lemon juice. This mix was mixed for 15 to 30 minutes until the sugar was uniformly dissolved.

The effective liquid mix was obtained at time of use by adding 150 kg of water to the concentrate in a container of suitable capacity.

The pumice stones were placed in a perforated receptacle which was plunged into the container containing the liquid mix for 5 minutes during which the pumice stones were impregnated with the said mix.

The perforated receptacle was removed from the liquid mix and the pumice stones left to drip to lose the excess liquid mix.

The pumice stones were then placed for 15 minutes in an oven from which all the oxygen had been driven out and replaced by nitrogen. The temperature of the oven was maintained to 550° C. After these 15 minutes at 550° C., the pumice stones were removed from the oven and left to cool.

The carbon content measured was then 3%.

To measure the degree of hydrophoby of the pumice stone obtained, a sample was placed in water for 3 minutes. After this time, the stones had absorbed less than 4% of water. The tests were extended up to 7 days of immersion in water. The pumice stones still had not absorbed more than 4% of water and less than 2% in weight had sunk.

Then, diesel fuel was made absorbed by these pumice stones. It was observed that after 4 minutes they had absorbed around 20% of their volume.

This batch of pumice stones impregnated with diesel fuel was then placed in the same oven as mentioned above, with the oxygen replaced by nitrogen, and the temperature was increased to 450° C. and the pumice stones left at this temperature for 20 minutes. It was then observed that the hydrocarbons contained in the pumice stones had evaporated. There is no calcination of the product but only heating of the product.

The pumice stones which had been subjected to this heat treatment were again used for another diesel fuel depollution operation and the same adsorption characteristics were observed, renewed after having repeated this test around ten times.

It was thus demonstrated that the process according to the invention allows porous minerals, and especially pumice stones, to be rendered hydrophobic by a technique which creates no environmental problems. Also, the buoyancy of pumice stones even charged with hydrocarbons was substantially greater than that of earlier products thus enabling a fast response on a body of water to be treated by depositing pumice stone aggregates and recovering them several days later. Also, the product according to the invention is almost indefinitely recyclable by the hydrocarbon desorption process without combustion which also allows secondary pollution problems to be avoided. Moreover, it can allow a recovery at least partial of the hydrocarbons by condensation of the gases given off by the heating of the pumice stones impregnated with hydrocarbons in an oxygen-free atmosphere.

Other tests have been done using treatment plant sludges as organic material for the preparation of the adsorbent product. The sludges used contained 20% of solid matter and 12% of organic matter. 200 litres of these sludges were mixed with 280 litres of water for 3 to 6 minutes. When this mix was homogeneous, the pumice stones were impregnated in it as described in the first example and the process was continued in the same manner.

In dried sludges, the organic matters contain 20 to 35% of elementary carbon. In sugar, this ratio is around 40%. But, as stated previously, the length of carbonated chains is higher in sludges which enables a lower loss of carbon during cracking. Thus, it was observed that the carbon loss during the cracking in this second example, with the use of sludges from biological treatment, is of 15 to 33%, whereas it is around 50 to 75% with the sugar-based mix of the previous example. In spite of this relative advantage, the use of sugar is still preferred for the reasons given above.

The invention is especially intended for the depollution of bodies of water, seas, rivers, etc., polluted by hydrocarbons but it can also be used, for example, in refineries to separate water from petrol or to absorb other chemical products. The product obtained according to the invention can also be used generally in the filtration domain. According to various applications, certain features of the product could be adapted, such as its particle size for example, or its carbon content. Lastly, the pumice stone can also be replaced by other minerals such as especially porous volcanic rocks such as perlite or zeolite.

1-13. (canceled)

14. An adsorbent product for the elimination of hydrocarbon pollutions present on the surface of water, said product being based on a porous mineral having adsorption properties which result from carbon formed on walls of pores of the porus mineral, the porous mineral being one pumice stone and perlite, the carbon formed on the walls of the pores being obtained by cracking an organic product previously impregnated into the pores of said mineral, and the product being hydrophobic.

15. The product according to claim 14, wherein the product is an organic product consisting mainly of one of sugar and treatment plant sludges.

16. A process for eliminating hydrocarbon pollutions present on the surface of water, comprising using the adsorbent product according to claim 14, spreading the adsorbent product on pollutant hydrocarbons, adsorbing the hydrocarbons, using said adsorbent product, placing the product impregnated with said hydrocarbons in a heat treatment unit brought, in the absence of oxygen, to a temperature of 200 to 450° C., and evaporating the hydrocarbons so that the product is thus returned to an initial condition and reusable.

17. The process according to claim 16, further comprising treating the evaporated hydrocarbons with a condensation system and recovering the evaporated hydrocarbons.

18. The process according to claim 16, further comprising obtaining the adsorbent product, by forming carbon on the walls of the pores of the porous mineral by cracking molecules of an organic product previously impregnated in the pores of the mineral.

19. The process for obtaining an adsorbent product according to claim 14, comprising forming carbon on the walls of the pores of the porous mineral by cracking molecules of an organic product previously impregnated in the pores of the mineral.

20. The process according to claim 18, wherein the organic product consists mainly of one of sugar and treatment plant sludges.

21. The process according to claim 20, further comprising, during the preparation of the product, immersing the porous mineral in a liquid mix including water and the organic product to impregnate the mineral with the mix and heating the impregnated mineral in a heat treatment unit, in the absence of oxygen, to bring the impregnated material to a sufficient temperature to decompose by cracking the molecules of the organic product and form a carbon deposit on the walls of the pores of the porous mineral.

22. The process according to claim 21, further comprising using a liquid mix including 10 to 20% of sugar in weight.

23. The process according to claim 21, further comprising using a liquid mix including lemon juice.

24. The process according to claim 21, comprising using an impregnation time between 3 and 10 minutes.

25. The process according to claim 21, comprising using a heating temperature between 500 and 600° C.

26. The process according to claim 21, further comprising maintaining a nitrogen atmosphere in the heat treatment unit.
